(19) United States
(12) Patent Application Publication
(10) Pub. No.: US 2009/0264572 A1
(43) Pub. Date: Oct. 22, 2009

(54) COATING COMPOSITIONS AND USES THEREOF

(76) Inventors: Chin-Yi LIAO, Tainan (TW); Chien-Chih CHU, Yilan (TW)

Correspondence Address: HOLLAND & KNIGHT LLP, 10 ST. JAMES AVENUE, BOSTON, MA, 02116-3889, US

(21) Appl. No.: 12/137,861

(22) Filed: Jun. 12, 2008

(30) Foreign Application Priority Data
Apr. 16, 2008 (TW) 097113833

(51) Int. Cl. C08L 83/06; C08G 65/332; C08K 3/22; C08K 3/30; C08K 3/26; C08K 3/34; C08L 67/00

(52) U.S. Cl. 524/423; 525/403; 525/418; 525/474; 524/497; 524/432; 524/493; 524/430; 524/425; 524/506

(57) ABSTRACT

A coating composition comprises a resin, an antistatic agent and an antistatic aid, wherein the antistatic aid is selected from a group consisting of a siloxane compound, a fluoro-compound and a combination thereof. The antistatic aid can generate a synergy effect with the antistatic agent, and carry the antistatic agent out of the coating surface, thus can obviously reduce the amount of antistatic agent to achieve the desired antistatic effect by using a small amount of antistatic aid. The coating composition can be applied to various products with antistatic needs.

### RELATED APPLICATION

This application claims priority to Taiwan Patent Application No. 097113833 filed on 16 Apr. 2008, the contents of which are incorporated herein by reference in their entirety.

### BACKGROUND OF THE INVENTION

### Field of the Invention

The present invention relates to a coating composition, particularly a coating composition with good anti-staticity.

In the photonics industry, various components are constructed by using plastic materials, which have high electrical insulation and thus produce static electricity easily due to friction. A minor static electricity easily creates stained contamination while serious static electricity impacts the performance of products and increases the defective products as a result.

In general, conventional coatings, which impart anti-staticity to a product, comprise a resin, an antistatic agent, a solvent and an additive. Currently, there are various antistatic agents existing in market, comprising conductive carbon black, conductive fibers, metal powders or metal oxides, organic or inorganic salts, surfactants and conductive polymers. However, various antistatic agents have different problems. For instance, adding conductive carbon black or metal powders easily generates stained contamination and decreases the transparency. The surfactants cannot effectively provide antistatic effect under an environment at low humidity. In addition, the cost of conductive polymers is too high.

Furthermore, one common problem often encountered in the above-mentioned antistatic agents is, when the amount of antistatic agents is added in increasing amounts, the quality of coating decreases even though the anti-staticity increases. Therefore, an antistatic agent that, in addition to possessing excellent antistatic effect, imparts products with satisfactory anti-staticity at a relatively small amount is highly desired in the art.

Taiwan Patent Laid-Open No. 200728360 discloses a light-scattering antistatic and bright thermoplastic composition comprising transparent polycarbonate, transparent acrylate-based polymeric particles and an antistatic agent. The polymeric particles have core-shell morphology and their diameter is 1 μm to 100 μm. Also, the fluoroalkane ammonium sulfonate is used as the antistatic agent in an amount of 0.1 wt % to 4.0 wt %. The result shows that a surface resistivity value of the film thus obtained is higher than 10¹⁴ Ω/sq. The antistatic effect cannot practically satisfy the need of current products.

Taiwan Patent Laid-Open No. 200720734 provides an optical film comprising a substrate, a resin layer and an antistatic agent, wherein the resin layer is disposed on the substrate and the antistatic agent is dispersed in the resin layer and is nano-particles with metal oxides. According to the disclosure of said patent application, although adding the antistatic agent provides a good antistatic effect, the adding amount reaches 20 wt % to 80 wt % of total composition.

Japan Patent Laid-Open No. 7-241502 provides an antistatic film comprising a coating layer formed on one or both sides thereof, wherein the coating layer comprises a phosphoric acid ester salt-based antistatic agent. The content of the antistatic agent in the coating layer ranges from 5 to 40 parts by weight, preferably from 10 to 30 parts by weight. If the amount exceeds 40 parts by weight, the antiblocking property and adhesion of the coating layer will be insufficient, and the antistatic effect will be poor if the amount is less than 5 parts by weight.

It has been found from previous studies that the prior art emphasizes the improvement of antistatic agents for antistatic products, rather than the study of antistatic aids. The inventors found that the amount of an antistatic agent in a coating composition can be reduced dramatically by using an antistatic aid, but still provides an antistatic effect equivalent to other product containing a relatively large amount of an antistatic agent.

### SUMMARY OF THE INVENTION

One objective of the present invention is to provide a coating composition, which comprises a resin, an antistatic agent and an antistatic aid, wherein the antistatic aid is selected from a group consisting of a siloxane compound, a fluoro-compound and a combination thereof. The antistatic aid can generate a synergy effect with the antistatic agent and carry the antistatic agent out of the coating surface, thus significantly reducing the amount of the antistatic agent and achieving the desired antistatic effect by using a small amount of antistatic aid.

### DESCRIPTION OF THE INVENTION

The coating composition according to the present invention can utilize any suitable resin, e.g. a thermosetting resin, which comprises (but is not limited to) an acrylate resin, a methacrylate resin, a polyamide resin, a polyurethane resin, a polyester resin, a polyimide resin, an alkyd resin, an epoxy resin, a fluoro-resin, a phenolic resin or combinations thereof, preferably an acrylate resin, a polyurethane resin or a combination thereof, and more preferably an acrylate resin. Optionally, the acrylate resin can bear one or more groups selected from a group consisting of hydroxyl (—OH), carboxyl (—COOH) and amino (—HN₂), preferably hydroxyl, such as hydroxyethyl acrylate (HEA), hydroxypropyl acrylate (HPA), 2-hydroxyethyl methacrylate (HEMA), hydroxypropyl methacrylate (HPMA) or mixtures thereof. The content of the resin, based on the total solid weight of the coating composition, ranges from about 50 wt % to about 99.55 wt %, preferably from about 60 wt % to about 99.55 wt %, and more preferably from about 70 wt % to about 97.85 wt %.

Generally, the antistatic agent used in the present invention is not restricted by any limitation, and it can be selected from a group consisting of a polyether polyol, a polyester polyol, a quaternary ammonium compound, an organic salt, an inorganic salt and combinations thereof. For instance, the non-limiting examples of the antistatic agent useful in the present invention comprise a polyether polyol, a sodium chloride, a potassium chloride, a lithium perchlorate, a potassium chlorate, a potassium nitrate, a sodium nitrate, a sodium carbonate, a vulcanized sodium cyanate, a fluoro-lithium imide salt, a pyridinium salt, an alkyltrimethylammonium salt, an alkylsulfonate salt or combinations thereof. The preferred antistatic agent can be any of the following: polyether polyol, a pyridinium salt, a lithium perchlorate or combinations thereof.

Generally, a small amount of antistatic agent will provide insufficient conductivity and a poor antistatic effect. On the other hand, when the content of antistatic agent is too high, it easily impacts the coating quality. The content of the antistatic agent in the coating composition of the present invention, based on the total solid weight of the coating composition, ranges from about 0.1 wt % to about 10 wt %, and preferably from about 0.1 wt % to about 5 wt % if an antistatic aid is provided.

The coating composition of the present invention further comprises an antistatic aid. By using the antistatic aid, the antistatic aid can generate a synergy effect with the antistatic agent and carry the antistatic agent out of the coating surface. As a result, the composition of the present invention can still provide antistatic effect equivalent to other compositions containing a relatively large amount of an antistatic agent using a small amount of the antistatic aid, and therefore can reduce the content of the antistatic agent to achieve the desired antistatic effect. The antistatic aid suitable for the coating composition of the present invention can be selected from a group consisting of a siloxane compound, a fluoro-compound and a combination thereof. The siloxane compound is represented by formula (1) or (2):

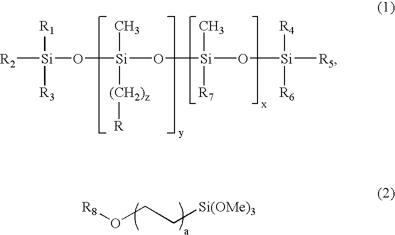

wherein,
each of R₁, R₂, R₃, R₄, R₅, R₆ and R₇ independently represents H, CH₃, C₂H₅, C₃H₇, OCH₃ or OC₂H₅;
each of x, y, z and a is independently an integer from 1 to 20;
R represents

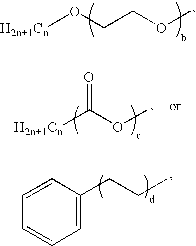

wherein n is an integer from 1 to 5, each of b and c is independently an integer from 1 to 20, and d is an integer from 0 to 20; and
R₈ represents

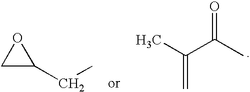

According to one embodiment of the coating composition of the present invention, the siloxane compound is represented by formula (1), wherein
each of R₁, R₂, R₃, R₄, R₅, R₆ and R₇ independently represents CH₃ or OCH₃;
each of x, y and z is independently an integer from 1 to 10; and
R represents

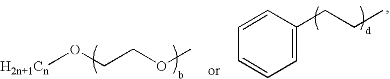

wherein n is an integer from 1 to 3, b is an integer from 1 to 10, and d is an integer from 0 to 5.

In addition, the antistatic aid used in the present invention can also be a fluoro-compound represented by formula (4):

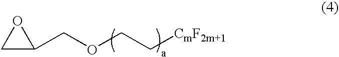

wherein m is an integer from 1 to 10, preferably from 3 to 7, and a is an integer from 1 to 20, preferably from 2 to 10. For instance, the non-limiting example of the fluoro-compound useful in the coating composition of the present invention comprises γ-glycidoxytrifluoropropane, γ-glycidoxypentafluorobutane, γ-glycidoxyheptafluoropentane and combinations thereof.

The antistatic aid used in the coating composition of the present invention is preferably a siloxane compound, which is represented by formula (3):

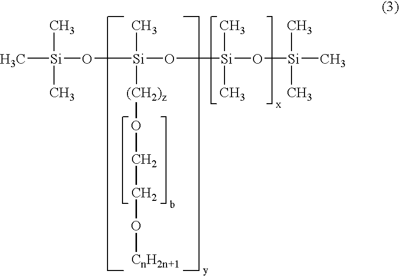

wherein each of x, y, z and b is independently an integer from 1 to 5 and n is an integer from 1 to 3. For instance, the non-limiting example of a siloxane compound used as the antistatic aid in the coating composition of the present invention comprises ether-modified polydimethylsiloxane, polyether-modified polydimethylsiloxane, hydroxy polydimethylsiloxane, ester-modified polydimethylsiloxane, polyester-modified polydimethylsiloxane, polydimethylsiloxane, octamethylcyclotetrasiloxane, phenylsiloxane, dimethicone, alkylmethylsiloxane, dimethicone copolyol or combinations thereof. The other example comprises γ-glycidoxypropyltrimethoxysilane, γ-glycidoxypropylmethdiethoxysilane, γ-metacryloxypropyltrimethoxysilane or combinations thereof.

According to the present invention, by adding a small amount of antistatic aid, the amount of the antistatic agent is reduced and the coating composition with improved antistatic effect can be obtained. Generally, based on the total solid weight of the coating composition, the content of the antistatic aid ranges from about 0.05 wt % to about 5 wt %, preferably from about 0.1 wt % to about 2 wt %, more preferably from about 0.2 wt % to about 1 wt %.

Depending on the uses of final products with coatings, the coating composition of the present invention can further comprise, if necessary, one or more other additives which are commonly used by persons having ordinary skill in the art. For instance, the additive used optionally comprises a crosslinking agent, an inorganic particulate, an adhesive promoter, a plasticizer, a filling agent, an UV stabilizer, a flow and leveling additive, a dispersant, an initiator, a catalyst and a stabilizer.

The crosslinking agent, which can be optionally added to the coating composition, is well-known by persons with ordinary skill in the art. Usually, the crosslinking agent selected from a group consisting of polyisocyanate, alkylated melamine-formaldehyde resin and a combination thereof, preferably polyisocyanate, can be used. Said crosslinking agent can produce chemical conjugation between molecules and molecules to form crosslinking. For instance, the acrylate resin with hydroxyl can react with polyisocyanate to form cross-linkage. Under the condition of adding the crosslinking agent, its content can range from about 0.1 wt % to about 30 wt %, preferably from about 0.3 wt % to about 20 wt %, based on the total solid weight of the coating composition.

A suitable polyisocyanate crosslinking agent can be selected from a group consisting of an aliphatic polyisocyanate, an aromatic polyisocyanate and a combination thereof. For instance, the non-limiting example of an aliphatic polyisocyanate comprises a cyclohexane diisocyanate dimer, trimer or an adduct thereof, a trimethyl cyclohexane diisocyanate dimer, trimer or an adduct thereof, a cyclohexane di(methylisocyanate) dimer, trimer or an adduct thereof, an isophorone diisocyanate dimer, trimer or an adduct thereof, or combinations thereof. The non-limiting example of an aromatic polyisocyanate comprises a toluene diisocyanate dimer, trimer or an adduct thereof, a xylene diisocyanate dimer, trimer or an adduct thereof, a diphenylmethane diisocyanate dimer, trimer or an adduct thereof, or combinations thereof.

The alkylated melamine-formaldehyde resin crosslinking agent suitable for the coating composition of the present invention can be methylated, ethylated, propylated or butylated melamine-formaldehyde resin, which comprises (but is not limited to) hexa(methyl formaldehyde)-melamine resin, hexa(ethyl formaldehyde)-melamine resin, tetra(methyl-formaldehyde)-diamino-melamine resin, tetra(methyl-formaldehyde)-bi(buthyl-formaldehyde)-melamine resin, tetra(methyl-formaldehyde)-bi(propyl-formaldehyde)-melamine resin or combinations thereof.

Furthermore, to prevent those substrates that absorb ultraviolet rays from yellowing, an inorganic particulate with ultraviolet-absorbing capacity can be optionally added to the coating composition, such as zinc oxide, silicon dioxide, titanium dioxide, aluminum oxide, calcium sulfate, barium sulfate, calcium carbonate or combinations thereof. The nano-grade particulate is commonly selected, wherein the particle diameter ranges preferably from about 1 nm to about 100 nm. When the inorganic particulate is present, its content normally ranges from about 1 wt % to about 10 wt %, based on the total solid weight of the coating composition.

To uniformly mix the various components contained in the composition and for the convenience of the subsequent coating process, the coating composition of the present invention can further comprise a solvent. The solvent can be provided by a solution with a binder or a solution with a crosslinking agent, or by additional adding. The solvent suitable for the coating composition of the present invention is well-known by persons with ordinary skill in the art and comprises (but is not limited to) benzene compounds, ester compounds, ketone compounds or combinations thereof. For instance, the non-limiting example of the benzene compound solvent comprises benzene, o-xylene, m-xylene, p-xylene, trimethylbenzene, styrene or combinations thereof. The non-limiting example of the ester compound solvent comprises ethyl acetate, butyl acetate, diethyl carbonate, ethyl formate, methyl acetate, ethoxybutyl acetate, ethoxypropyl acetate, propylene glycol monomethyl ether or combinations thereof. The non-limiting example of the ketone compound solvent comprises acetone, methyl ethyl ketone, methyl isobutyl ketone or combinations thereof.

In the case that the coating composition of the present invention contains a solvent, based on the total solid weight of the coating composition, the content of the solvent ranges from about 30 wt % to about 90 wt %, preferably from about 40 wt % to about 80 wt %.

The coating composition of the present invention can be coated directly onto any suitable substrate surface, and provides the substrate surface with good anti-staticity, wherein its surface resistivity is less than 10¹³ Ω/□, preferably less than 10¹² Ω/□, more preferably between 10⁸ and 10¹¹ Ω/□ (Ω/□ representing ohm/square meters). There is no special limitation on said substrate and can be of any material, such as metal, alloy, glass, computer case, wood, plastic, leather or stone.

The plastic substrate is well-known by persons with ordinary skill in the art. For instance, the substrate can comprise a material consisting of a polyacrylate resin (e.g., polymethyl methacrylate (PMMA)), a polyester resin (e.g., polyethylene naphthalate (PEN) or polyethylene terephthalate (PET)), a polyimide resin, a polycycloolefin resin, a polycarbonate resin, a polyurethane resin, a triacetate cellulose (TAC) or combinations thereof.

The abovementioned plastic substrate can be used in lamping devices as the substrate of an optical film, such as advertising light boxes and panel displays. The thickness of the substrate is usually determined by product need. All of the thicknesses of the substrate used in the current technology can be used in the present invention. A thickness ranging from about 16 μm to 200 μm is preferred.

The coating composition of the present invention can be coated on one or two surfaces of the substrate through any suitable approach, for instance, bar coating, slot die coating, gravure coating, slide coating, curtain coating or spray coating.

Subsequently, the coating composition is dried at an appropriate temperature, and the solvent is evaporated to carry out polymerization reaction, thus forming a coating layer. The drying process can be carried out by a forced-volatilization approach of venting or heating (e.g. venting hot air).

According to one embodiment of the present invention, the coating can be carried out to provide products with anti-staticity by the following steps:
(I) mixing a resin, an antistatic agent, an antistatic aid, and an optional crosslinking agent and another additive to formulate a coating solution, wherein the solution can be diluted if necessary by adding a solvent thereto;
(II) coating the coating solution on the surface of a substrate by a bar coating rod; and
(III) feeding the coated substrate to a dryer for heating at an appropriate temperature for several minutes.

### EXAMPLES

### Example 1

One hundred parts by the weight of acrylate resin solution E-7713 (about 25% of solid content, Eternal Chemical Co., Ltd.) was mixed with 0.3 part by the weight of non-ionic antistatic agent (Ref. No. 9398-0155-R2, Marubishi Oil Chemical Company Ltd., about 30% of solid content), 0.3 part by the weight of antistatic aid Dow Corning 57 Additive (Dow Coming Corporation, polyether-modified polydimethylsiloxane) and 1 part by the weight of crosslinking agent Desmodur N75 (Bayer AG, isocyanate, about 75% of solid content). After uniform stirring, a coating composition was obtained. After setting and defoaming, the composition was coated on one side of a polyethylene terephthalate (PET) film (T100G-38, 38 μm thickness, produced by Mitsubishi Chemical Corporation) by a bar coating rod. Subsequently, the coated film was dried at 120° C. for 2 minutes to evaporate the solvent, and a coating layer with a solid coating of about 20 g/m² was obtained.

The sample thus obtained was carried out for an evaluation of surface resistivity. Using the resistivity meter (MCP-HT450, Mitsubishi Chemical Corporation), charged at 100 voltage for 60 seconds, the surface resistivity (ohm/sq.) of the sample was measured. The measurement result is listed in Table 1.

### Comparative Example 1

The preparing steps and measuring methods of Example 1 were repeated without adding the antistatic aid. The measurement result is listed in Table 1.

### Comparative Example 2

The preparing steps and measuring methods of Example 1 were repeated by adding 3 parts by the weight of the non-ionic antistatic agent instead of 0.3 parts by the weight and without adding the antistatic aid. The measurement result is listed in Table 1.

### Example 2

The preparing steps and measuring methods of Example 1 were repeated but 0.3 part by the weight of antistatic aid BYK-333 (BYK Additives & Instruments, polyether-modified alkylsiloxane) was used. The measurement result is listed in Table 1.

### Example 3

The preparing steps and measuring methods of Example 1 were repeated but 1 part by the weight of antistatic aid BYK-340 (BYK additives & instruments, fluoro-compound) was used. The measurement result is listed in Table 1.

### Example 4

The preparing steps and measuring methods of Example 1 were repeated but 1 part by the weight of antistatic aid KBM-403 (Shin-Etsu Chemical Co., Ltd., epoxy silane coupling agent) was used. The measurement result is listed in Table 1.

### Example 5

The preparing steps and measuring methods of Example 1 were repeated but 1 part by the weight of antistatic aid KBM-503 (Shin-Etsu Chemical Co., Ltd., acrylic silane coupling agent) was used. The measurement result is listed in Table 1.

### Comparative Example 3

The preparing steps and measuring methods of Example 1 were repeated without adding the antistatic agent. The measurement result is listed in Table 1.

### Comparative Example 4

The preparing steps and measuring methods of Example 1 were repeated but 0.3 part by the weight of antistatic aid BYK-361 (BYK Additives & Instruments, acrylate copolymer) was used. The measurement result is listed in Table 1.

### Example 6

The preparing steps and measuring methods of Example 1 were repeated but 0.5 part by the weight of antistatic agent PEL-100 (Japan Carlit Co., Ltd., lithium perchlorate/polyether polyol) was used. The measurement result is listed in Table 1.

### Example 7

The preparing steps and measuring methods of Example 1 were repeated but 0.3 part by the weight of antistatic agent IL-C1 (Koei Chemical Co., Ltd., pyridinium derivative) and 0.5 part by the weight of crosslinking agent Desmodur 3390 (Bayer AG, isocyanate, about 90% of solid content) were used. The measurement result is listed in Table 1.

### Example 8

126.6 parts by the weight of acrylate resin solution Eterac 7363-ts-50 (about 50% of solid content, Eternal Chemical Co., Ltd.) was mixed with 45 parts by the weight of methyl ethyl ketone and toluene, 3 parts by the weight of 35 nm zinc oxide/barium sulfate, 1 part by the weight of antistatic agent PEL-100 (Japan Carlit Co., Ltd., lithium perchlorate/polyether polyol), 1 part by the weight of antistatic aid BYK-333 (BYK Additives & Instruments, polyether-modified alkylsiloxane) and 18.4 parts by the weight of crosslinking agent Desmodur 3390 (Bayer AG, isocyanate, about 90% of solid content) in order. After uniform stirring, a coating composition was obtained. After setting and defoaming, the coating composition was coated onto the substrate of UX-150 film (produced by Teijin Limited) by a bar coating rod. Subsequently, the coated substrate is dried at 120° C. for 2 minutes to evaporate the solvent, and a coating layer with a solid coating of about 10 g/m² was obtained.

### Comparative Example 5

The preparing steps and measuring methods of Example 8 were repeated without adding the antistatic aid. The measurement result is listed in Table 1.

TABLE 1

| | Surface Resistivity |
|---|---|
| | (Ω/sq.) |
| Example 1 | 4.62 × 10¹⁰ |
| Example 2 | 6.80 × 10¹⁰ |
| Example 3 | 6.30 × 10¹¹ |
| Example 4 | 2.44 × 10¹² |
| Example 5 | 3.86 × 10¹² |
| Example 6 | 4.16 × 10¹⁰ |
| Example 7 | 2.39 × 10¹⁰ |
| Example 8 | 2.46 × 10¹² |
| Comparative Example 1 | >10¹⁴ |
| Comparative Example 2 | 9.14 × 10¹⁰ |
| Comparative Example 3 | >10¹⁴ |
| Comparative Example 4 | >10¹⁴ |
| Comparative Example 5 | >10¹⁴ |

It can be found from Examples 1 to 8 that the coating composition of the present invention comprises a resin; an antistatic agent such as polyether polyol, pyridinium salt, lithium perchlorate or a mixture thereof; and an antistatic aid selected from a group consisting of a siloxane compound, a fluoro-compound and a combination thereof exhibits good antistatic effect.

By comparing the result of Example 1 with Comparative Example 1, it can be found that if the coating composition of the present invention does not contain an antistatic aid, the antistatic effect is poor.

By comparing the result of Example 1 with Comparative Example 2, it can be found that if the coating composition of the present invention does not contain an antistatic aid, it is required to add a large amount of an antistatic agent to achieve an equivalent antistatic effect.

By comparing the result of Example 1 with Comparative Example 3, it can be found that if the coating composition of the present invention comprises an antistatic aid only without the antistatic agent, the antistatic effect is poor because the antistatic aid does not exhibit an antistatic effect.

By comparing the result of Example 1 with Comparative Example 4, it can be found that if the coating composition of the present invention does not comprise a siloxane compound, a fluoro-compound or a combination thereof as the antistatic aid, the antistatic effect is poor.

By comparing the result of Example 8 with Comparative Example 5, it can be found that if the coating composition of the present invention does not comprise an antistatic aid, the antistatic effect is poor.

It has been proven that the coating composition according to the present invention utilizes a siloxane compound, a fluoro-compound or a combination thereof as an antistatic aid, and then it can exhibit excellent antistatic effect using only a small amount of an antistatic agent.

The above examples are intended to further illustrate the present invention, but not to limit the scope of the present invention. Any modifications or equal replacements that can be easily accomplished by persons skilled in the art also belong to the scope of the disclosure in the specification of the present application and the claims as appended.

What is claimed is:

1. A coating composition, which comprises:
a resin;
an antistatic agent, and is characterized by
an antistatic aid selected from a group consisting of a siloxane compound, a fluoro-compound and a combination thereof.

2. The coating composition of claim 1, wherein the antistatic aid is a siloxane compound.

3. The coating composition of claim 2, wherein the siloxane compound is represented by formula (1) or (2): 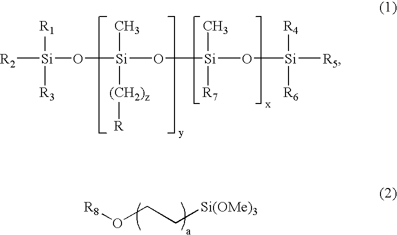
wherein,
each of R₁, R₂, R₃, R₄, R₅, R₆ and R₇ independently represents H, CH₃, C₂H₅, C₃ or OC₂H₅;
each of x, y, z and a is independently an integer from 1 to 20;
R represents 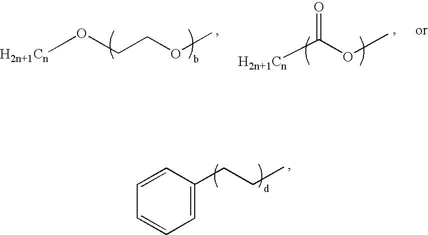
wherein n is an integer from 1 to 5, each of b and c is independently an integer from 1 to 20, and d is an integer from 0 to 20; and
R₈ represents

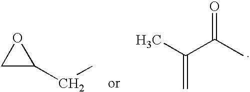

4. The coating composition of claim 2, wherein the siloxane compound is represented by formula (1), and wherein,
each of R₁, R₂, R₃, R₄, R₅, R₆ and R₇ independently represents CH₃ or OCH₃;
each of x, y and z is independently an integer from 1 to 10;
R represents 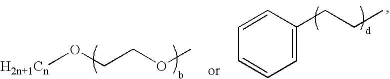
wherein n is an integer from 1 to 3, b is an integer from 1 to 10, and d is an integer from 0 to 5.

5. The coating composition of claim 4, wherein the siloxane compound is represented by formula (3): 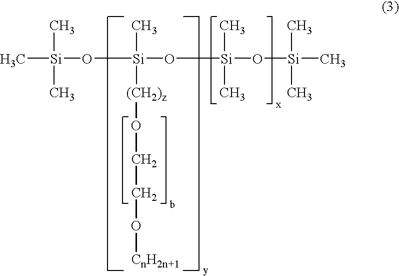
wherein each of x, y, z and b is independently an integer from 1 to 5 and n is an integer from 1 to 3.

6. The coating composition of claim 5, wherein the siloxane compound is selected from a group consisting of ether-modified polydimethylsiloxane, polyether-modified polydimethylsiloxane, hydroxy polydimethylsiloxane, ester-modified polydimethylsiloxane, polyester-modified polydimethylsiloxane, polydimethylsiloxane, octamethylcyclotetrasiloxane, phenylsiloxane, dimethicone, alkylmethylsiloxane, dimethiconecopolyol, γ-glycidoxypropyltrimethoxysilane, γ-glycidoxypropylmethdiethoxysilane, γ-metacryloxypropyltrimethoxysilane and combinations thereof.

7. The coating composition of claim 1, wherein the antistatic aid is a fluoro-compound.

8. The coating composition of claim 7, wherein the fluoro-compound is represented by formula (4): 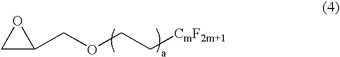
wherein m is an integer from 1 to 10 and a is an integer from 1 to 20.

9. The coating composition of claim 8, wherein the fluoro-compound is selected from a group consisting of γ-glycidoxytrifluoropropane, γ-glycidoxypentafluorobutane, γ-glycidoxyheptafluoropentane and combinations thereof.

10. The coating composition of claim 1, wherein the content of the antistatic aid, based on the total solid weight of the coating composition, ranges from about 0.05 wt % to about 5 wt %.

11. The coating composition of claim 10, wherein the content of the antistatic aid, based on the total solid weight of the coating composition, ranges from about 0.1 wt % to about 2 wt %.

12. The coating composition of claim 11, wherein the content of the antistatic aid, based on the total solid weight of the coating composition, ranges from about 0.2 wt % to about 1 wt %.

13. The coating composition of claim 1, wherein the resin is selected from a group consisting of an acrylate resin, a methacrylate resin, a polyamide resin, a polyurethane resin, a polyester resin, a polyimide resin, an alkyd resin, an epoxy resin, a fluoro-resin, a phenolic resin and combinations thereof.

14. The coating composition of claim 13, wherein the resin is selected from a group consisting of an acrylate resin, a polyurethane resin and a combination thereof.

15. The coating composition of claim 1, wherein the content of the resin, based on the total solid weight of the coating composition, ranges from about 50 wt % to about 99.55 wt %.

16. The coating composition of claim 15, wherein the content of the resin, based on the total solid weight of the coating composition, ranges from about 60 wt % to about 99.5 wt %.

17. The coating composition of claim 1, wherein the antistatic agent is selected from a group consisting of a polyether polyol, a polyester polyol, a quaternary ammonium compound, an organic salt, an inorganic salt and combinations thereof.

18. The coating composition of claim 1, wherein the content of the antistatic agent, based on the total solid weight of the coating composition, ranges from about 0.1 wt % to about 10 wt %.

19. The coating composition of claim 18, wherein the content of the antistatic agent, based on the total solid weight of the coating composition, ranges from about 0.1 wt % to about 5 wt %.

20. The coating composition of claim 1, wherein the coating composition further comprises an additive selected from a group consisting of a crosslinking agent, an inorganic particulate, an adhesive promoter, a plasticizer, a filling agent, an UV stabilizer, a flow and leveling additive, a dispersant, an initiator, a catalyst, a stabilizer and combinations thereof.

21. The coating composition of claim 20, wherein the crosslinking agent is selected from a group consisting of polyisocyanate, alkylated melamine-formaldehyde resin and a combination thereof.

22. The coating composition of claim 20, wherein the crosslinking agent is polyisocyanate.

23. The coating composition of claim 20, wherein the content of the crosslinking agent, based on the total solid weight of the coating composition, ranges from about 0.1 wt % to about 30 wt %.

24. A coating composition, which comprises:
about 60 wt % to about 99.5 wt % of an acrylate resin;
about 0.1 wt % to about 10 wt % of a polyether polyol as an antistatic agent;
about 0.1 wt % to about 2 wt % of a polysiloxane resin as an antistatic aid; and
about 0.3 wt % to about 20 wt % of polyisocyanate as a crosslinking agent; based on the total solid weight of the coating composition, wherein the polysiloxane resin is represented by formula (3): 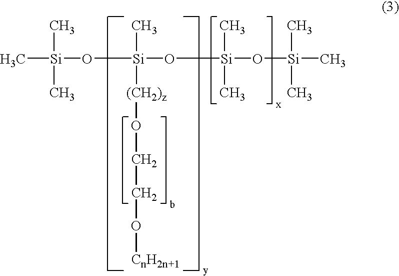
wherein each of x, y, z and b is independently an integer from 1 to 5 and n is an integer from 1 to 3.

25. A coating composition, which comprises, based on the total solid weight of the coating composition,
about 70 wt % to about 97.85 wt % of acrylate resin;
about 0.1 wt % to about 5 wt % of a polyether polyol as an antistatic agent;
about 0.2 wt % to about 1 wt % of a polysiloxane resin as an antistatic aid;
about 0.3 wt % to about 20 wt % of polyisocyanate as a crosslinking agent; and
about 1 wt % to about 10 wt % of an inorganic particulate,
wherein
the inorganic particulate is selected from a group consisting of zinc oxide, silicon dioxide, titanium dioxide, aluminum oxide, calcium sulfate, barium sulfate, calcium carbonate and combinations thereof;
the polysiloxane resin is represented by formula (3): 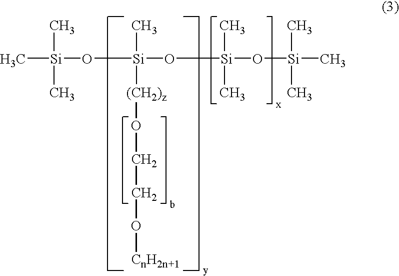
wherein each of x, y, z and b is independently an integer from 1 to 5 and n is an integer from 1 to 3.

26. The coating composition of claim 25, wherein the particle diameter of the inorganic particulate ranges from about 1 nm to about 100 nm.
